(19) United States
(12) Patent Application Publication
(10) Pub. No.: US 2024/0312312 A1
(43) Pub. Date: Sep. 19, 2024

(54) AUTOMATED WAGERING SYSTEMS AND METHODS

(71) Applicant: Jeremy Ernest Flint, East Setauket, NY (US)

(72) Inventor: Jeremy Ernest Flint, East Setauket, NY (US)

(21) Appl. No.: 18/419,531

(22) Filed: Jan. 22, 2024

Related U.S. Application Data
(60) Provisional application No. 63/427,096, filed on Nov. 21, 2022.

(51) Int. Cl. G07F 17/32; G06Q 50/34

(52) U.S. Cl. CPC G07F 17/3288; G06Q 50/34

(57) ABSTRACT

Computer-implemented automated wagering methods, systems, and computer-readable media are described.

### FIELD

Some implementations are generally related to computerized wagering, and, in particular, to automated wagering systems and methods.

### BACKGROUND

People who bet on sporting events and other events may not always find themselves in a situation where they are able to place bets as a game or other event develops. For example, a user may be travelling or in a location where a connection to an online wagering system isn't available or isn't permitted. Moreover, some types of wagers a user may desire to place may require constant real time monitoring of a sporting event or other event as it develops. A user may not desire to place wagers or bets, but may not be able to monitor the real time situation of the sporting event or other event in order to make informed wagers.

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

FIG. 1 is a block diagram of an example system and a network environment which may be used for one or more implementations described herein.

FIG. 2 is a flowchart showing an example method of automated wagering in accordance with some implementations.

FIG. 3 is a flowchart of an example method of training a model for automated wagering in accordance with some implementations.

FIG. 4 is a block diagram of an example computing device which may be used for one or more implementations described herein.

### DETAILED DESCRIPTION

Some implementations include automated wagering methods and systems.

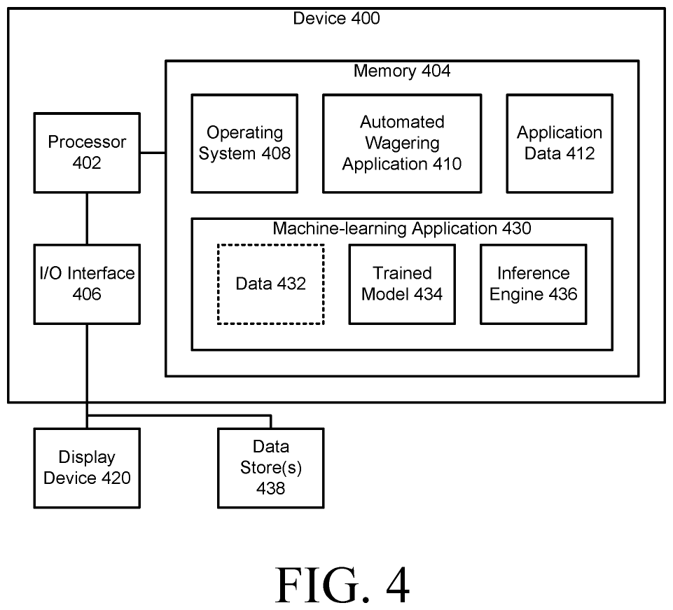

When performing automated wagering functions, it may be helpful for a system to suggest automated wagers and/or to make predictions about wagers to suggest. To make predictions or suggestions, a probabilistic model (or other model as described below in conjunction with FIG. 4) can be used to make an inference (or prediction) about aspects of automated wagering such as wagers to suggest. Accordingly, it may be helpful to make an inference regarding a probability that an automated wager would be of interest to a user. Other aspects can be predicted or suggested as described below.

The inference based on the probabilistic model can include predicting automated wagers in accordance with image (or other data) analysis and confidence score as inferred from the probabilistic model. The probabilistic model can be trained with data including previous automated wagering data. Some implementations can include generating automated wagering predictions or suggestion based on previous wagers and current or future event data for events for which wagers are accepted.

Particular implementations may realize one or more of the following advantages. An advantage of permitting a user to place automated wagers based on parameters set by the user or suggested by the system based on methods and system described herein utilizing automated wagering data and confidence. Yet another advantage is that the methods and systems described herein can dynamically learn new thresholds (e.g., for confidence scores, etc.) and provide suggestions for automated wagering that match the new thresholds. The systems and methods presented herein automatically provide automated wagering suggestions that are more likely to be accepted by users and that likely are more accurate.

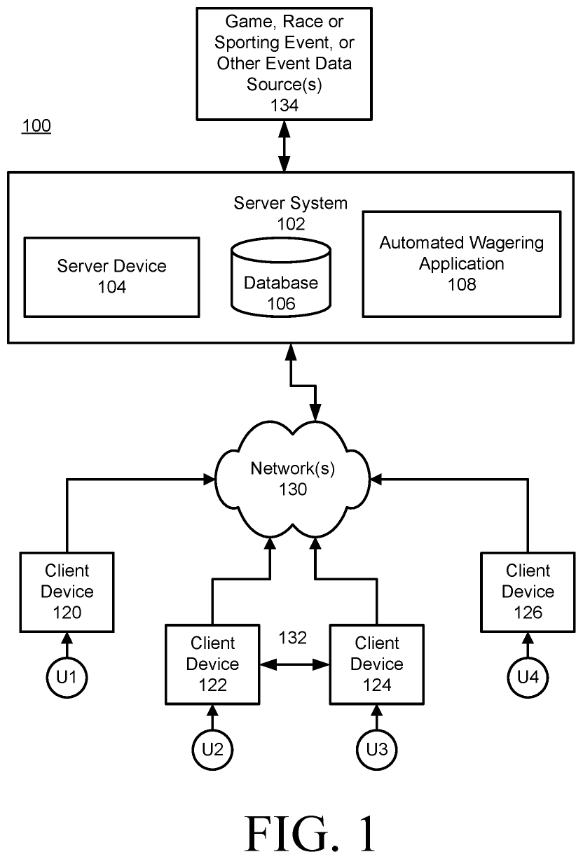

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104, a database 106 or other data store or data storage device, and an automated wagering application 108. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols. The network environment 100 can also include one or more event data sources 134.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide automated wagering functions.

Various implementations of features described herein can use any type of system and/or service. Any type of electronic device can make use of features described herein. Some implementations can provide one or more features described herein on client or server devices disconnected from or intermittently connected to computer networks.

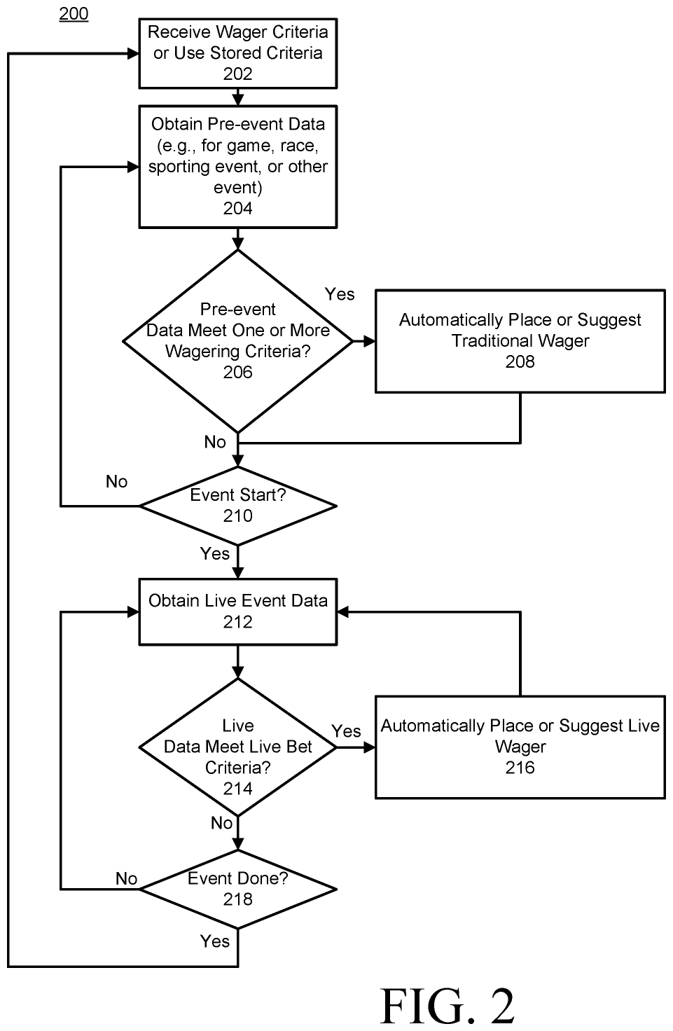

FIG. 2 is a flowchart showing an example method of automated wagering in accordance with some implementations. Processing begins at 202, where wager criteria are received or retrieved from storage. The wager criteria can include the various parameters to evaluate and trigger a wager to be placed when the parameters or conditions are met.

In the example automated wagers below, an amount of $250.00 is used as a base example for all bets. Any programmable variable interacts with live changing odds to elicit a ‘call’ on a bet. Automated wagers can include add-ons like props and parlays. While sports are used an example herein, the disclosed subject matter can be used for anything where bets or wagers are being taken, e.g., sporting events, political races, award ceremonies, etc.

### Football

Pregame condition-Dolphins are playing the Bills and the Dolphins are favored at −3.5 with an over/under of 45.

### 1. Pregame Bet Scenario

If the line moves to −2.5 place bet of $250.00
If the over/under moves to 42 or below place a bet of $250

### 2. In Game Condition

In game probability is 55% Dolphins win; if probability reaches 65% at any point place bet of $250.00
The score at the end of the first quarter is 7-0, if new in game over/under for the second half is below 28.5 place bet of $250.00
Dolphins player X (in this case would select the QB) is injured, bet $250.00 on Bills to win or cover.

### Basketball

Odds and lines would be pretty similar to Football with variation in points
Would add as in-game condition—if player X (for example Steph Curry) has Y amount of points (15 for this example) by the end of Z (in this case the first) quarter, bet $250.00 on Golden State to win or cover.

### Soccer

Pregame condition—Aston Villa vs Southampton
Aston Villa is +110; Draw +250; Southampton +255
If line for Villa moves to +150 or greater place $250.00 bet
Over/Under is 2.5 goals at +250
If line moves to 2.0 over below place bet of $250.00
If the money line moves to +300 or above place bet of $250.00
Line for player X (for this example Ollie Watkins) to score anytime in the game is +150.
If line moves above +175 place bet of $250.00
Player X (for this example Coutinho) is injured pregame
Place bet on Draw or Southampton to win
In game condition
Villa is winning 1-0 at half.
If in game line for draw moves to +300 or above place bet of $250.00
Game score can be a factor or not
In game player X (for this example Martinez, goalkeeper for Aston Villa) is injured place bet of $250.00 on draw or Southampton win

### Golf

Pre-Tournament Conditions-players are all given odds to win tournament, rounds, be in top 5, 10; etc.
Matsuyama is +2500 to win; +400 for top 5 finish; +180 top 10 finish
If top 5 finish moves to over +450 place bet of $250.00

### In Tournament Conditions

Odds will continue to shift as tournament play continues
If Matsuyama enters top 5 at any time auto bet $250.00 to win
If Matsuyama's line for top 5 reaches over +450 at any time place bet of $250.00.
Processing continues to 204.

At 204, obtain pregame data for an event (e.g., a sporting event, race, or other event). The pregame data can be provided by one or more external services or can be entered by an operator. Processing continues to 206.

At 206, it is determined whether pregame data meets the criteria for one or more automated wagers. If so, processing continues to 208. Otherwise, processing continues to 210.

At 208, a traditional wager (i.e., pregame) corresponding to the wager for which criteria were met is automatically placed or suggested. Processing continues to 210.

At 210, it Some implementations can include determined if the game (or other event) has started. If so, processing continues to 212. Otherwise, processing continues to 204.

At 212, live game data is obtained. Processing continues to 214.

At 214, it is determined whether live game data meets the criteria for one or more automated live wagers. If so, processing continues to 216. Otherwise, processing continues to 218.

At 216, a live wager (i.e., pregame) corresponding to the wager for which criteria were met is automatically placed or suggested. Processing continues to 212.

At 218, it is determined if the game is done. If so, processing continues to 202. Otherwise, processing continues to 212.

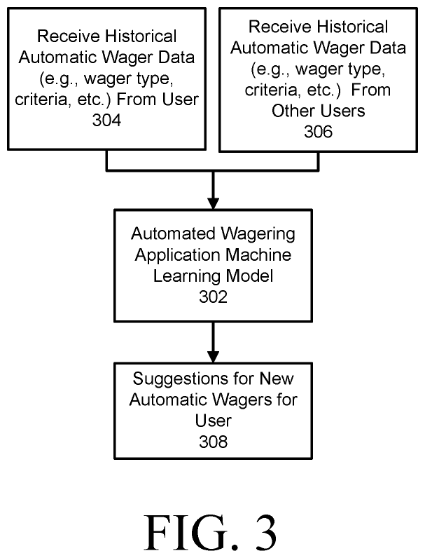

FIG. 3 is a flowchart of an example method of training a model for automated wagering in accordance with some implementations. An automated wagering application machine learning model 302 is configured to receive historical automatic wagering data of a user (304) and historical automatic wagering data from one or more other users (306). As discussed below in connection with FIG. 4, the automated wagering application machine learning model is trained using the input data 304 and 306, the model can output suggestions for new automatic wagers for the user 308.

FIG. 4 is a block diagram of an example device 400 which may be used to implement one or more features described herein. In one example, device 400 may be used to implement a client device, e.g., any of client devices 120-126 shown in FIG. 1. Alternatively, device 400 can implement a server device, e.g., server device 104, etc. In some implementations, device 400 may be used to implement a client device, a server device, or a combination of the above. Device 400 can be any suitable computer system, server, or other electronic or hardware device as described above.

One or more methods described herein (e.g., automated wagering as shown in FIGS. 2-3) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 400 includes a processor 402, a memory 404, and I/O interface 406. Processor 402 can be one or more processors and/or processing circuits to execute program code and control basic operations of the device 400. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 402 may include one or more co-processors that implement neural-network processing. In some implementations, processor 402 may be a processor that processes data to produce probabilistic output, e.g., the output produced by processor 402 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 404 is typically provided in device 400 for access by the processor 402 and may be any suitable processor-readable storage medium, such as random-access memory (RAM), read-only memory (ROM), Electrically Erasable Read-only Memory (EEPROM), Flash memory, etc., suitable for storing instructions for execution by the processor, and located separate from processor 402 and/or integrated therewith. Memory 404 can store software operating on the server device 400 by the processor 402, including an operating system 408, machine-learning application 430, automated wagering application 410, and application data 412. Other applications may include applications such as a data display engine, web hosting engine, image display engine, notification engine, social networking engine, etc. In some implementations, the machine-learning application 430 and automated wagering application 410 can each include instructions that enable processor 402 to perform functions described herein, e.g., some or all of the methods of FIGS. 2-3.

The machine-learning application 430 can include one or more NER implementations for which supervised and/or unsupervised learning can be used. The machine learning models can include multi-task learning based models, residual task bidirectional LSTM (long short-term memory) with conditional random fields, statistical NER, etc. The Device can also include an automated wagering application 410 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 430 may utilize Bayesian classifiers, support vector machines, neural networks, or other learning techniques. In some implementations, machine-learning application 430 may include a trained model 434, an inference engine 436, and data 432. In some implementations, data 432 may include training data, e.g., data used to generate trained model 434. For example, training data may include any type of data suitable for training a model for automated wagering tasks, such as images, labels, thresholds, etc. associated with automated wagering described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 434, training data may include such user data. In implementations where users permit use of their respective user data, data 432 may include permitted data.

In some implementations, data 432 may include collected data such as previous automated or manual wagers of a one or more users, data about events for which wagers are being accepted (e.g., sports events, etc.). In some implementations, training data may include synthetic data generated for the purpose of training, such as data that is not based on user input or activity in the context that is being trained, e.g., data generated from simulated conversations, computer-generated images, etc. In some implementations, machine-learning application 430 excludes data 432. For example, in these implementations, the trained model 434 may be generated, e.g., on a different device, and be provided as part of machine-learning application 430. In various implementations, the trained model 434 may be provided as a data file that includes a model structure or form, and associated weights. Inference engine 436 may read the data file for trained model 434 and implement a neural network with node connectivity, layers, and weights based on the model structure or form specified in trained model 434.

Machine-learning application 430 also includes a trained model 434. In some implementations, the trained model 434 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 432 or application data 414. Such data can include, for example, images, e.g., when the trained model is used for automated wagering functions. Subsequent intermediate layers may receive as input output of nodes of a previous layer per the connectivity specified in the model form or structure. These layers may also be referred to as hidden layers. A final layer (e.g., output layer) produces an output of the machine-learning application. For example, the output may be a set of recommended wagers, etc. depending on the specific trained model. In some implementations, model form or structure also specifies a number and/or type of nodes in each layer.

In different implementations, the trained model 434 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 434 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 432, to produce a result.

For example, training may include applying supervised learning techniques. In supervised learning, the training data can include a plurality of inputs (e.g., data of a user's previous wagers and data corresponding to current or future events to wager on) and a corresponding expected output for each input. Based on a comparison of the output of the model with the expected output, values of the weights are automatically adjusted, e.g., in a manner that increases a probability that the model produces the expected output when provided similar input.

In some implementations, training may include applying unsupervised learning techniques. In unsupervised learning, only input data may be provided and the model may be trained to differentiate data, e.g., to cluster input data into a plurality of groups, where each group includes input data that are similar in some manner. For example, the model may be trained to identify wagers to recommend to a user that are associated with automated wagering suggestions.

In another example, a model trained using unsupervised learning may cluster words based on the use of the words in data sources. In some implementations, unsupervised learning may be used to produce knowledge representations, e.g., that may be used by machine-learning application 430. In various implementations, a trained model includes a set of weights, or embeddings, corresponding to the model structure. In implementations where data 432 is omitted, machine-learning application 430 may include trained model 434 that is based on prior training, e.g., by a developer of the machine-learning application 430, by a third-party, etc. In some implementations, trained model 434 may include a set of weights that are fixed, e.g., downloaded from a server that provides the weights.

Machine-learning application 430 also includes an inference engine 436. Inference engine 436 is configured to apply the trained model 434 to data, such as application data 414, to provide an inference. In some implementations, inference engine 436 may include software code to be executed by processor 402. In some implementations, inference engine 436 may specify circuit configuration (e.g., for a programmable processor, for a field programmable gate array (FPGA), etc.) enabling processor 402 to apply the trained model. In some implementations, inference engine 436 may include software instructions, hardware instructions, or a combination. In some implementations, inference engine 436 may offer an application programming interface (API) that can be used by operating system 408 and/or automated wagering application 410 to invoke inference engine 436, e.g., to apply trained model 434 to application data 414 to generate an inference.

Machine-learning application 430 may provide several technical advantages. For example, when trained model 434 is generated based on unsupervised learning, trained model 434 can be applied by inference engine 436 to produce knowledge representations (e.g., numeric representations) from input data, e.g., application data 414. For example, a model trained for automated wagering tasks may produce predictions and confidences for given input information about a current or future event for which wagers are accepted. A model trained for suggesting and/or making automated wagers may produce a suggestion for one or more wagers based on input data or other information. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 436.

In some implementations, knowledge representations generated by machine-learning application 430 may be provided to a different device that conducts further processing, e.g., over a network. In such implementations, providing the knowledge representations rather than the images may provide a technical benefit, e.g., enable faster data transmission with reduced cost. In another example, a model trained for automated wagering may produce an automated wagering signal for input data about one or more events (e.g., sport competition, etc.) being processed by the model.

In some implementations, machine-learning application 430 may be implemented in an offline manner. In these implementations, trained model 434 may be generated in a first stage and provided as part of machine-learning application 430. In some implementations, machine-learning application 430 may be implemented in an online manner. For example, in such implementations, an application that invokes machine-learning application 430 (e.g., operating system 408, one or more of automated wagering application 410 or other applications) may utilize an inference produced by machine-learning application 430, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 434, e.g., to update embeddings for trained model 434.

In some implementations, machine-learning application 430 may be implemented in a manner that can adapt to particular configuration of device 400 on which the machine-learning application 430 is executed. For example, machine-learning application 430 may determine a computational graph that utilizes available computational resources, e.g., processor 402. For example, if machine-learning application 430 is implemented as a distributed application on multiple devices, machine-learning application 430 may determine computations to be carried out on individual devices in a manner that optimizes computation. In another example, machine-learning application 430 may determine that processor 402 includes a GPU with a particular number of GPU cores (e.g., 1000) and implement the inference engine accordingly (e.g., as 1000 individual processes or threads).

In some implementations, machine-learning application 430 may implement an ensemble of trained models. For example, trained model 434 may include a plurality of trained models that are each applicable to same input data. In these implementations, machine-learning application 430 may choose a particular trained model, e.g., based on available computational resources, success rate with prior inferences, etc. In some implementations, machine-learning application 430 may execute inference engine 436 such that a plurality of trained models is applied. In these implementations, machine-learning application 430 may combine outputs from applying individual models, e.g., using a voting-technique that scores individual outputs from applying each trained model, or by choosing one or more particular outputs. Further, in these implementations, machine-learning application may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 408 or one or more other applications, e.g., automated wagering application 410.

In different implementations, machine-learning application 430 can produce different types of outputs. For example, machine-learning application 430 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 430 may produce an output video with a particular effect applied, e.g., rendered in a comic-book or particular artist's style, when trained model 434 is trained using training data from the comic book or particular artist, etc. In some implementations, machine-learning application 430 may produce an output based on a format specified by an invoking application, e.g., operating system 408 or one or more applications, e.g., automated wagering application 410. In some implementations, an invoking application may be another machine-learning application. For example, such configurations may be used in generative adversarial networks, where an invoking machine-learning application is trained using output from machine-learning application 430 and vice-versa.

Any of software in memory 404 can alternatively be stored on any other suitable storage location or computer-readable medium. In addition, memory 404 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 404 and any other type of storage (magnetic disk, optical disk, magnetic tape, or other tangible media) can be considered “storage” or “storage devices.”

I/O interface 406 can provide functions to enable interfacing the server device 400 with other systems and devices. Interfaced devices can be included as part of the device 400 or can be separate and communicate with the device 400. For example, network communication devices, storage devices (e.g., memory and/or database 106), and input/output devices can communicate via I/O interface 406. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 406 can include one or more display devices 420 and one or more data stores 438 (as discussed above). The display devices 420 that can be used to display content, e.g., a user interface of an output application as described herein. Display device 420 can be connected to device 400 via local connections (e.g., display bus) and/or via networked connections and can be any suitable display device. Display device 420 can include any suitable display device such as an LCD, LED, or plasma display screen, CRT, television, monitor, touchscreen, 3-D display screen, or other visual display device. For example, display device 420 can be a flat display screen provided on a mobile device, multiple display screens provided in a goggles or headset device, or a monitor screen for a computer device.

The I/O interface 406 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 4 shows one block for each of processor 402, memory 404, I/O interface 406, and software blocks 408, 410, and 430. These blocks may represent one or more processors or processing circuitries, operating systems, memories, I/O interfaces, applications, and/or software modules. In other implementations, device 400 may not have all of the components shown and/or may have other elements including other types of elements instead of, or in addition to, those shown herein. While some components are described as performing blocks and operations as described in some implementations herein, any suitable component or combination of components of environment 100, device 400, similar systems, or any suitable processor or processors associated with such a system, may perform the blocks and operations described.

In some implementations, logistic regression can be used for personalization (e.g., personalizing automated wagering suggestions based on a user's pattern of automated wagering activity). In some implementations, the prediction model can be handcrafted including hand selected labels and thresholds. The mapping (or calibration) from ICA space to a predicted precision within the automated wagering space can be performed using a piecewise linear model.

In some implementations, the automated wagering system could include a machine-learning model (as described herein) for tuning the system (e.g., selecting automated wagering labels and corresponding thresholds) to potentially provide improved accuracy. Inputs to the machine learning model can include ICA labels, an image descriptor vector that describes appearance and includes semantic information about automated wagering. Example machine-learning model input can include labels for a simple implementation and can be augmented with descriptor vector features for a more advanced implementation. Output of the machine-learning module can include a prediction of automated wagering wagers to suggest to a user.

One or more methods described herein (e.g., methods of FIGS. 2-3) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer implemented method comprising:
Automatically placing or suggesting a pre-event wager when one or more conditions corresponding to an event are met; and
Automatically placing or suggesting a live wager during the event when one or more live wager conditions are met.
